(19) United States
(12) Patent Application Publication
(10) Pub. No.: US 2025/0220082 A1
(43) Pub. Date: Jul. 3, 2025

(54) NETWORK NODE CAPABILITY DETECTION FOR DATA CHANNEL APPLICATIONS

(71) Applicant: QUALCOMM Incorporated, San Diego, CA (US)

(72) Inventors: Kefeng Zhang, Beijing (CN); Haris Zisimopoulos, London (GB); Carlos Marcelo Dias Pazos, Carlsbad, CA (US); Yongze Chen, San Diego, CA (US); Shilin Ding, Shenzhen (CN)

(21) Appl. No.: 18/867,317

(22) PCT Filed: Jul. 22, 2022
(86) PCT No.: PCT/CN2022/107327

§ 371 Date: Nov. 19, 2024

(51) Int. Cl. H04L 67/141; H04L 67/02

(52) U.S. Cl. CPC H04L 67/141; H04L 67/02

(57) ABSTRACT

This disclosure provides systems, methods, and devices for wireless communication that support determination of network node application support. In a first aspect, a first network node may include a memory having first code stored thereon and at least one processor coupled to the memory. The at least one processor may be configured to execute the first code to cause the first network node to connect to a second network node, transmit a HTTP request for first application information to the second network node, receive an HTTP response including the first application information from the second network node, determine one or more applications supported by the first network node based on the first application, display information indicative of the one or more applications, or select a first application of the one or more applications. Other aspects and features are also claimed and described.

### TECHNICAL FIELD

Aspects of the present disclosure relate generally to wireless communication systems, and more particularly, to data channel operation. Some features may enable and provide improved communications, including network node capability detection for data channel applications.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a network node includes a memory having first code stored thereon and at least one processor coupled to the memory. The at least one processor is configured to execute first code to cause the first network node to connect to a second network node, transmit a hypertext transfer protocol (HTTP) request for first application information to the second network node, receive an HTTP response including the first application information from the second network node, and determine one or more applications supported by the first network node based on the first application information. The at least one processor is further configured to execute first code to cause the first network node to at least one of: display information indicative of the one or more applications, or select a first application of the one or more applications.

In an additional aspect of the disclosure, a method of wireless communication performed by a first network node may include connecting to a second network node, transmitting a HTTP request for first application information to the second network node, receiving a HTTP response including the first application information from the second network node, and determining one or more applications supported by the first network node based on the first application information. The method of wireless communication further includes at least one of displaying information indicative of the one or more applications or selecting a first application of the one or more applications.

In an additional aspect of the disclosure, a network node includes a memory having first code stored thereon and at least one processor coupled to the memory. The at least one processor is configured to execute first code to cause the first network node to connect to a second network node, receive a HTTP request for first application information from the second network node, and transmit a HTTP response including the first application information to the second network node.

In an additional aspect of the disclosure, a method of wireless communication performed by a first network node may include connecting to a second network node, receiving a HTTP request for first application information from the second network node, and transmitting an HTTP response including the first application information to the second network node.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 is a block diagram illustrating an example wireless communication system that supports wireless node data channel application support determination according to one or more aspects.

FIG. 4 is a timing diagram illustrating a wireless communication system that supports network node application support determination according to one or more aspects.

FIG. 5 is a flow diagram illustrating an example process that supports network node data channel application support determination according to one or more aspects.

FIG. 6 is a flow diagram illustrating an example process that supports network node data channel application support determination according to one or more aspects.

FIG. 7 is a flow diagram illustrating an example process that supports network node data channel application support determination according to one or more aspects.

FIG. 8 is a block diagram of an example base station that supports network node data channel application support determination according to one or more aspects.

FIG. 9 is a block diagram of an example UE that supports network node data channel application support determination according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz−7.125 GHz) and FR2 (24.25 GHz−52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz−300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

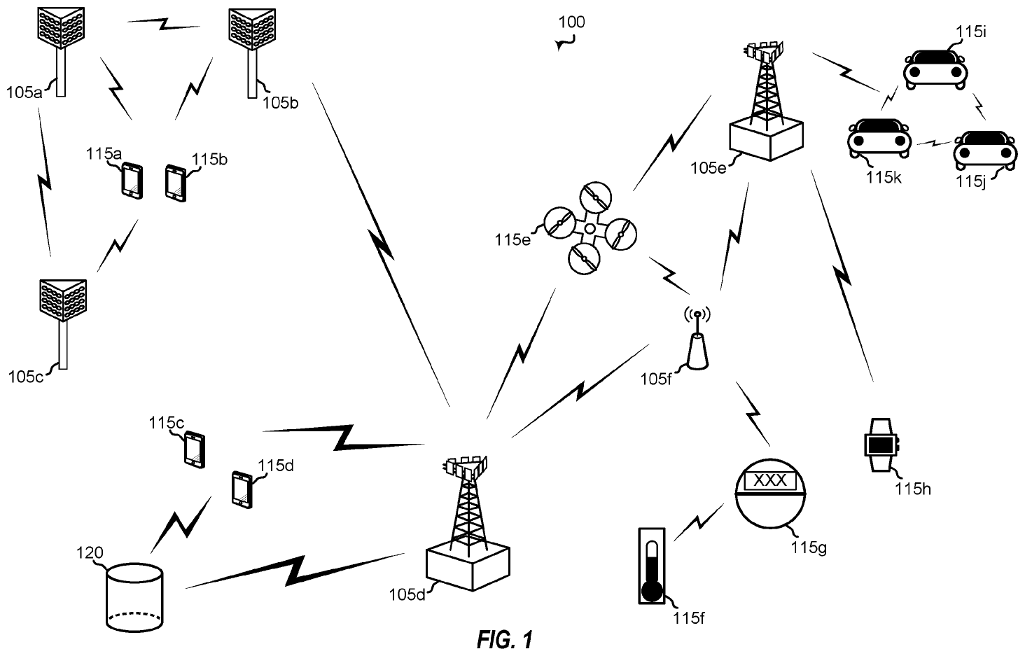

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Wireless network 100 of implementations may also include one or more wirelessly connected servers, such as data channel server 120. In some embodiments, the data channel server 120 may be or may be integrated into a base station, such as base station 105. The data channel server may facilitate communication between various network nodes, such as UEs 115. As one example, the data channel server 120 may an internet protocol multimedia subsystem (IMS) data channel server for facilitating communication between UEs 115 via data channels connected between the UEs 115 and the data channel server 120 for communication applications. In some cases, the data channel server may facilitate communication between UEs 115 by connecting data channels between UEs 115 using different connection protocols and/or technologies, such as 5G, WiFi, Bluetooth, public switched telephone network, and other protocols and/or technologies.

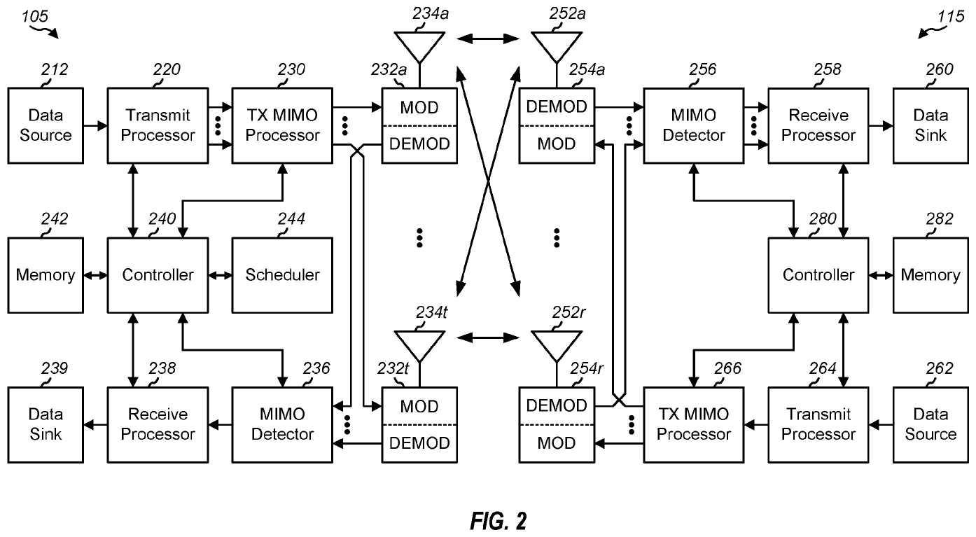

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

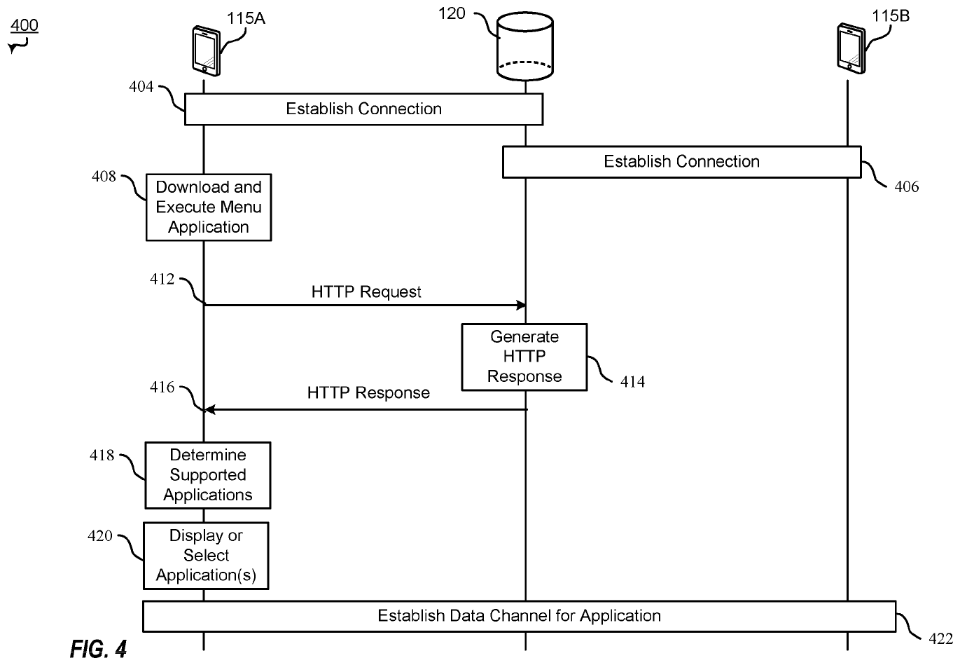

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 4-7, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

Data channel server 120 may facilitate communication between UEs 115. In particular data channel server 120 may connect to multiple UEs 115 to connect the UEs 115 via data channels, such as IMS data channels. The data channel server 120 may store and support a variety of applications, such as video chat applications, voice chat applications, text chat applications, and other applications, to facilitate communication between UEs 115 via data channels. UEs 115 may connect to the data channel server 120 to download applications for communication with other UEs 115 via data channels and to connect with other UEs 115 via data channels.

Different data channel applications may have different capability requirements, such as requiring different hardware and software resources for use of the applications to communicate between UEs. For example, a video chat application may require access to both a camera and a microphone of the UEs 115 to facilitate use of a video chat application to communicate using a data channel between the UEs 115. As one particular example, UEs 115 communicating using data channels via a data channel server 120 may be data channel multimedia telephony service for IMS (DCMTSI) UEs.

A UE 115 may present a user with a variety of applications available from the data channel server 120 for use in communicating with another UE 115 over one or more data channels. However, the UE 115 may not possess the requisite hardware or software capabilities to properly use all of the available applications. A user's experience may be negatively impacted if the user selects an application for which the user's UE does not possess the required hardware or software capabilities, the application is downloaded, and the application fails to perform due to hardware or software inadequacies of the UE 115. Furthermore, such downloads may increase the power consumption and use of available processing capacity of a data channel server and a UE, while returning little to no benefit for such increases.

In order to reduce use of resources and negative impact on a user experience, a user may be presented with only applications for which the user's UE 115 possesses the required hardware and/or software capabilities or an indication of which applications are supported by and unsupported by the user's UE 115. To do so, the UE 115 and the data channel server 120 may exchange network node capability information for the UE 115, containing information regarding the hardware or software capabilities of the UE 115, or capability requirement information for one or more applications, containing information regarding the hardware or software capability requirements of each of the one or more applications. After exchanging such information, the UE 115 or the data channel server 120 may determine one or more applications supported by the UE 115.

Transmission of capability requirement information or network node capability information between a UE 115 and a data channel server 120 may require use of network resources. One option for transmission of such information is during an IMS registration procedure, while a connection between the UE 115 and the data channel server 120 is being established. However, transmission of UE capability information while a connection is being established, such as during IMS registration by a DCMTSI UE 115, may impact the reliability and speed of IMS registration and data traffic on all network nodes located between the UE and the data channel server, such as proxy-call session control function (P-CSCF) network nodes, interrogating call session control function (I-CSCF) network nodes, session initiation protocol (SIP) call session control function (S-CSCF) network nodes, IMS application server (IMS-AS) network nodes, home subscriber server network nodes, and other network nodes. Furthermore, some UEs may lack support for reporting application layer capabilities to the communication layer. Capabilities of UEs may also be subject to rapid change, causing capability information uploaded to a data channel server during an IMS registration procedure to become outdated and increasing the burden on a mobile network operator managing tracking of capabilities for multiple UEs.

In the aspects described herein, transmission of capability requirement information or network node capability information between a UE 115 and a data channel server 120 after the UE 115 is connected to the data channel server, such as via a bootstrap data channel, may reduce or avoid impact on IMS registration and network nodes located between the UE and the data channel server. For example, the UE 115 may transmit network node capability information detailing one or more hardware or software capabilities of the UE 115 to the data channel server 120 using an HTTP request for application information. The data channel server 120 may transmit an HTTP response including application information to the UE 115. The application information may include respective capability requirement information for one or more applications detailing hardware and/or software functionality required to use the respective applications or parts of the respective applications. Alternatively or additionally, the application information may include information indicative of whether network node capability information received from the UE 115 satisfies one or more respective capability requirements of each of one or more applications. For example, the application information transmitted to the UE 115 by the data channel server 120 may include a list of applications having respective capability requirements satisfied by network node capability requirement information received from the UE.

The UE 115 may determine, based on the application information received from the data channel server 120, one or more applications supported by the UE 115. The UE 115 may then display information indicative of the one or more applications. Alternatively or additionally, the UE may select a first application from the one or more applications for downloading from the data channel server. For example, the UE 115 may display a list of applications supported by the UE 115 for selection by a user. When the user provides a selection of one of the displayed applications, the UE may download the selected application from the data channel server. The UE 115 may then connect to a second UE 115 via a second data channel for communication using the downloaded application. As another example, the UE may select the first application from the one or more applications using artificial intelligence (AI) or machine learning (ML). For example, the UE may utilize the application information or the network node capability information in one or more AI or ML processes, such as AI—or ML—assisted predictive application selection operations.

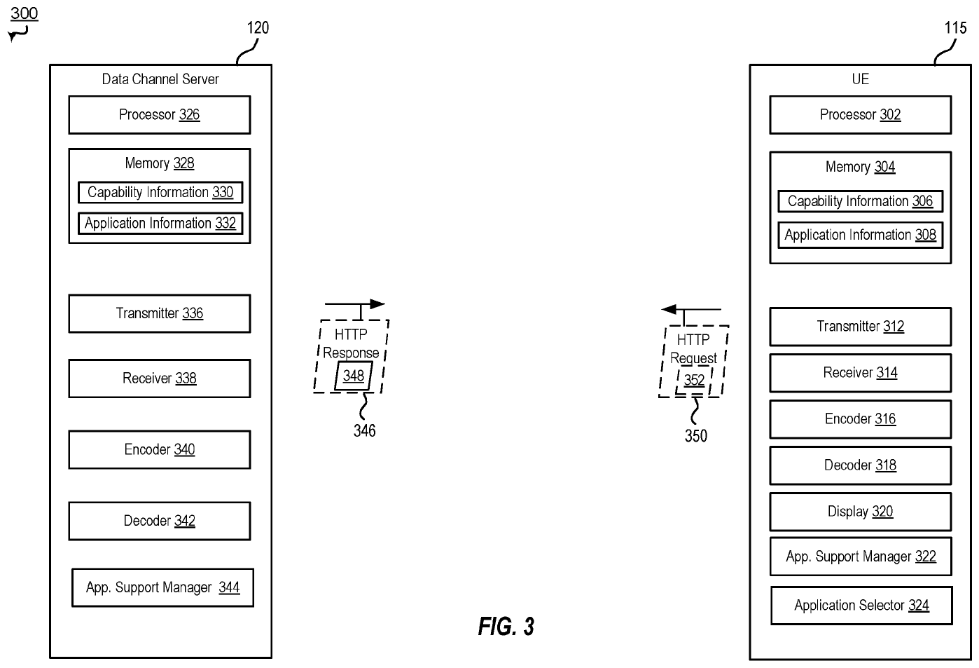

FIG. 3 is a block diagram of an example of a wireless communication system 300 that supports network node data channel application support determination in accordance with aspects of the present disclosure. In some examples, wireless communications system 300 may implement aspects of wireless communication system 100. For example, wireless communication system 300 may include a network, such as one or more network nodes. For example, wireless communication system 300 may include UEs, base stations, data channel servers, and other network nodes.

UE 115 may include a variety of components (such as structural, hardware components) used for carrying out one or more functions described herein. For example, these components may include one or more processors 302 (hereinafter referred to collectively as “processor 302”), one or more memory devices 304 (hereinafter referred to collectively as “memory 304”), one or more transmitters 312 (hereinafter referred to collectively as “transmitter 312”), and one or more receivers 314 (hereinafter referred to collectively as “receiver 314”). Processor 302 may be coupled to and configured to execute instructions stored in memory 304 to perform the operations described herein. In some implementations, processor 302 includes or corresponds to one or more of receive processor 258, transmit processor 264, and controller 280, and memory 304 includes or corresponds to memory 282.

As illustrated in the example of FIG. 3, a first network node corresponds to data channel server 120 which may be or may be integrated in a network node, such as a base station. A second network node corresponds to a UE 115. Data channel server 120 and UE 115 may be configured to communicate via an established connection. For example, data channel server 120 and UE 115 may connect with each other using a first data channel, such as a bootstrap data channel. Once the connection between the data channel server 120 and the UE 115 is established, the UE 115 and the data channel server 120 may communicate with each other via HTTP requests, such as HTTP request 350, and HTTP responses, such as HTTP response 346.

The processor 302 may be configured to execute first code to cause the processor to perform operations described herein. The memory 304 of the UE 115 may store capability information 306, such as information detailing one or more hardware or software capabilities of the UE 115, and application information 308, such as information detailing applications available for download from or supported by data channel server 120 and, in some embodiments, capability requirements of such applications. The UE 115 may transmit capability information 306 in the HTTP request 350, such as capability information 352 of HTTP request 350. For example, the UE 115 may determine capability information regarding one or more hardware or software capabilities of the UE 115 and may store such information 306 in the memory 304. The UE 115 may receive application information 308 in an HTTP response 346, such as application information 348, and may store the application information 308 in the memory 304. The application information 308 may, for example, include a list of one or more applications, information indicative of whether the one or more applications are supported by the UE, or respective capability requirement information for each of one or more applications.

The UE 115 may include a transmitter 312 for transmitting the HTTP request 350 and a receiver 314 for receiving the HTTP response 346. Transmitter 312 is configured to transmit reference signals, control information and data to one or more other devices, and receiver 314 is configured to receive references signals, synchronization signals, control information and data from one or more other devices. For example, transmitter 312 may transmit signaling, control information and data to, and receiver 314 may receive signaling, control information and data from, base station 105. In some implementations, transmitter 312 and receiver 314 may be integrated in one or more transceivers. Additionally or alternatively, transmitter 312 or receiver 314 may include or correspond to one or more components of UE 115 described with reference to FIG. 2. The UE 115 may include an encoder 316 for encoding data and a decoder 318 for decoding data. The UE 115 may include a display 320 for displaying information to a user. For example, the UE 115 may cause the display 320 to display a list of one or more applications determined, by the UE 115, to be supported by the UE 115 based on the application information 308.

The UE 115 may include an application support manager 322 for determining whether applications are supported by the UE 115 based on capability information 306 or application information 308. For example, the application support manager 322 may include code executable by the processor 302 to cause the UE 115 to collect capability information 306, to receive and transmit HTTP requests and responses, or to compare the capability information 306 of the UE 115 with capability requirement information of the application information 308 to determine one or more applications having respective capability requirements satisfied by the capabilities of the UE 115. The application support manager 322 may also include code executable by the processor 302 to cause the UE 115 to download one or more applications from the data channel server 120. Such applications may be stored as application information 308.

The UE 115 may include an application selector 324. The application selector 324 may include code for execution by the processor 302 to cause the UE 115 to receive an input from a user selecting one or more applications displayed on the display 320 for download from the data channel server 120. Alternatively or additionally, the application selector 324 may include code for execution by the processor 302 to cause the UE to execute one or more machine learning or AI algorithms to automatically select one or more applications for downloading from the data channel server 120.

The data channel server 120 may include a processor 326 and a memory 328 coupled to the processor 326. Data channel server 120 may include a variety of components (such as structural, hardware components) used for carrying out one or more functions described herein. For example, these components may include one or more processors 326 (hereinafter referred to collectively as “processor 326”), one or more memory devices 328 (hereinafter referred to collectively as “memory 328”), one or more transmitters 336 (hereinafter referred to collectively as “transmitter 336”), and one or more receivers 338 (hereinafter referred to collectively as “receiver 338”). Processor 326 may be configured to execute instructions stored in memory 328 to perform the operations described herein. In some implementations, processor 326 includes or corresponds to one or more of receive processor 238, transmit processor 220, and controller 240, and memory 328 includes or corresponds to memory 242. For example, data channel server 120 may be integrated in a base station 105.

The processor 326 may be configured to execute first code to cause the processor to perform operations described herein. The memory 328 of the data channel server 120 may store capability information 330, received from one or more UEs, and application information 332. The data channel server 120 may transmit application information 332 in the HTTP response 346, such as application information 348 of HTTP response 346. Application information 332 stored by the data channel server may include application information, such as capability requirement information, for one or more applications. The application information 332 may include a list of applications available for downloading from the data channel server 120. As one example, application information 332 may include respective capability requirements for each of multiple applications, specifying hardware or software functionality that a UE must possess in order to execute each respective application or specific functions of each respective application. Application information 332 may also include information indicating whether a specific UE possesses capabilities, such as hardware or software capabilities, that satisfy respective capability requirements of one or more applications stored by the memory 328 of the data channel server 120, such as determined based on capability information 330 received in an HTTP request 350. In particular, application information 332 may include a list of applications supported by a UE 115, the list determined based on capability information 330 received from the UE 115. Application information 332 may include a list of supported applications for each of multiple UEs connected to the data channel server 120. Application information 332 may include one or more applications, such as executable files of applications, available for download by the UE 115. The data channel server 120 may receive capability information 330 in an HTTP request 350, such as capability information 352, and may store the capability information 330 in the memory 328. In some embodiments, the capability information 330 may include capability information received from and detailing capabilities of multiple UEs.

The data channel server 120 may include a transmitter 336 for transmitting the HTTP response 346 and a receiver 338 for receiving the HTTP request 350. Transmitter 336 is configured to transmit reference signals, synchronization signals, control information and data to one or more other devices, and receiver 338 is configured to receive reference signals, control information and data from one or more other devices. For example, transmitter 336 may transmit signaling, control information and data to, and receiver 338 may receive signaling, control information and data from, UE 115. In some implementations, transmitter 336 and receiver 338 may be integrated in one or more transceivers. Additionally or alternatively, transmitter 336 or receiver 338 may include or correspond to one or more components of base station 105 described with reference to FIG. 2. The data channel server 120 may include an encoder 340 for encoding data and a decoder 342 for decoding data.

The data channel server 120 may include an application support manager 344 for determining whether applications are supported one or more UEs connected to the data channel server based on capability information 330 or application information 332. For example, the application support manager 344 may include code executable by the processor 326 to cause the data channel server 120 to receive and transmit HTTP requests and responses or to compare the capability information 330 of the UE 115 with capability requirement information of the application information 332 to determine one or more applications having respective capability requirements satisfied by the capabilities of the UE 115. The application support manager 344 may also include code executable by the processor 326 to cause the data channel server 120 to transmit one or more applications from the data channel server 120 to the UE 115. Such applications may be stored as application information 332.

In some implementations, wireless communications system 300 implements a 5G NR network. For example, wireless communications system 300 may include multiple 5G-capable UEs 115 and multiple 5G-capable base stations 105 having integrated data channel servers 120, such as UEs and base stations configured to operate in accordance with a 5G NR network protocol such as that defined by the 3GPP.

FIG. 4 is a timing diagram 400 illustrating an example of a wireless communication system that supports network node data channel application support determination according to one or more aspects. The example of FIG. 4 includes similar devices to the devices described in FIGS. 1, 2, and 3, such as first UE 115A, second UE 115B, and data channel server 120.

At 404, the first UE 115A and the data channel server 120 may establish a connection. Establishing a connection may, for example, include establishing a bootstrap data channel, such as a bootstrap IMS data channel. At 406, the second UE 115B and the data channel server 120 may establish a connection.

At 408, the first UE 115A may download and execute a menu application, such as a bootstrap menu application, from the data channel server 120. The first UE 115A may, for example, download the menu application using a bootstrap data channel between the first UE 115A and the data channel server 120. In some embodiments, the menu application may be preloaded on the UE 115A, and the UE 115A may execute the menu application without downloading the menu application from the data channel server 120. Executing the menu application may, for example, include collecting network node capability information for the first UE 115A. In some embodiments, the UE 115A may not execute a menu application and may communicate with the data channel server 120 without the menu application.

At 412, the first UE 115A may transmit an HTTP request to the data channel server 120. The HTTP request may be transmitted using an established data channel between the first UE 115A and the data channel server 120, such as a bootstrap data channel. In some embodiments, transmitting the HTTP request may include generation of the HTTP request. The HTTP request may, for example, be a get request, such as a first get request following establishment of the connection at 404, such as a first get request following IMS call setup. The get request may, for example, include a query to a root universal resource locator (URL). The HTTP request may be a request for first application information from the data channel server 120. In some embodiments, the first UE 115A may include network node capability information of the first UE 115A in the HTTP request. For example, the HTTP request may include a query string including a list of hardware or software capabilities of the first UE 115A. In particular, network node capability information of the first UE 115A may include a list of network node capabilities of the UE 115A and may be included in the HTTP request as name=value pairs with ampersands as separators in the request URL. Alternatively or additionally, network node capability information of the first UE 115A may be included in a dedicated defined HTTP header or in an HTTP request body, such as in XML or JSON format, of the HTTP request to avoid limits with respect to URL length. In some embodiments, the HTTP request may include a request for application information without network node capability information. In some embodiments, transmitting the HTTP request may be performed by the menu application, and in other embodiments transmitting the HTTP request may be otherwise performed by the first UE 115A.

At 414, the data channel server 120 may generate an HTTP response including application information. Generation of the HTTP response may include determination of one or more applications available for download from or supported by the data channel server 120, determination of one or more respective capability requirements of the one or more applications, or determination of whether network node capability information received from the UE 115A in the HTTP request of 412 satisfies one or more respective capability requirements of the one or more respective applications. For example, in some embodiments, such as when the data channel server 120 does not have access to network node capability information for the first UE 115A, the data channel server may generate an HTTP response including application information that includes a list of one or more applications available for download from or supported by the data channel server and one or more respective capability requirements of each respective application of the one or more applications. Thus, the data channel server 120 may generate an HTTP response at 414 that includes a list of applications and one or more capability requirements for each of the applications. The data channel server 120 may store multiple applications and capability requirement information for each of the applications. In some embodiments, such as when the data channel server 120 has access to network node capability information received from the UE 115A requesting application information, the data channel server 120 may compare capability information of the requesting UE 115A with capability requirement information of the one or more applications stored or supported by the data channel server 120. For example, a video chat application may have capability requirements specifying that a UE must have camera and microphone capabilities to run the application, and the data channel server may determine whether camera and microphone capabilities are included in network node capability information received from the UE 115A. The data channel server may generate application information indicating which applications are supported by the UE 115A, such as a list of applications having capability requirements satisfied by the network node capability information of the UE, or information indicating which applications are supported by the UE to be included with a list of all applications. Generation of the HTTP response at 414 may include generation of application information including a list of applications supported by or available for download from the data channel server 120, capability requirement information, such as a list of capabilities for each application detailing network node capabilities required for use of each application, or information indicating whether network node capability information of the UE satisfies one or more capability requirements of each respective application of one or more applications supported by or available for download from the data channel server 120.

At 416, the data channel server 120 may transmit an HTTP response to the first UE 115A. The HTTP response may include application information as discussed herein. The HTTP response may be transmitted using an established data channel between the data channel server 120 and the first UE 115A, such as a bootstrap data channel.

At 418, the first UE 115A may determine one or more supported applications based on the application information received in the HTTP response. For example, if the HTTP response includes information indicative of whether the network node capability information of the UE satisfies one or more respective requirements of each respective application of one or more applications identified by the application information, such as a list of applications supported by the UE, the UE may select all applications identified as supported by the UE in the application response. If the HTTP response includes a list of applications supported by or available for download from the data channel server 120 and respective capability requirement information for each respective application of the list of applications, the UE may compare network node capability information of the UE 115A, such as network node capability information stored in a memory of the UE 115A, with capability requirement information for each respective application to determine which applications have capability requirements that are satisfied by the capabilities of the UE 115A. Applications having some or all capability requirements satisfied by the network node capability information of the UE may be determined to be supported by the UE. Determination of the supported applications at 418 may be performed by the menu application or may be otherwise performed by the UE 115A.

At 420, the UE 115A may display or select applications of the one or more determined supported applications. For example, the UE may display a list of applications supported by the UE for a user and allow the user to input selection of an application for downloading from the data channel server 120. Alternatively, the UE 115A may display a list of applications including applications that are not supported by the UE 115A along with indicators indicating which applications are not supported by the UE 115A. As one example, applications that are not supported by the UE 115A may be listed with faded or greyed out text or icons. As another example, the UE may automatically select one or more applications of the one or more supported applications for download from the data channel server 120 using one or more machine learning or AI algorithms. For example, a supported application may be selected for automatic download based on user behavior. Selection of one or more supported applications may also include downloading of the one or more applications from the data channel server. Display and selection of one or more supported applications may be performed by the menu application or may be otherwise performed by the first UE 115A.

At 422, the first UE 115A, data channel server 120, and second UE 115B may establish one or more data channels for one or more selected applications. For example, the data channel server 120 may act as an intermediary facilitating connection between the first UE 115A and the second UE 115B via a data channel for a selected application supported by both UEs 115A-B. In some embodiments, the data channel server 120 may perform similar operations with respect to second UE 115B, and additional UEs, as performed with respect to UE 115A, to determine applications supported by second UE 115B. Thus, the application for which a data channel is established at 422 may be an application supported by both the first UE 115A and the second UE 115B. The first UE 115A and the second UE 115B may communicate with each other using the selected application via the established data channel. For example, the selected application may be a video chat application and the first UE 115A and the second UE 115B may transmit and receive video chat data for the application using the established data channel.

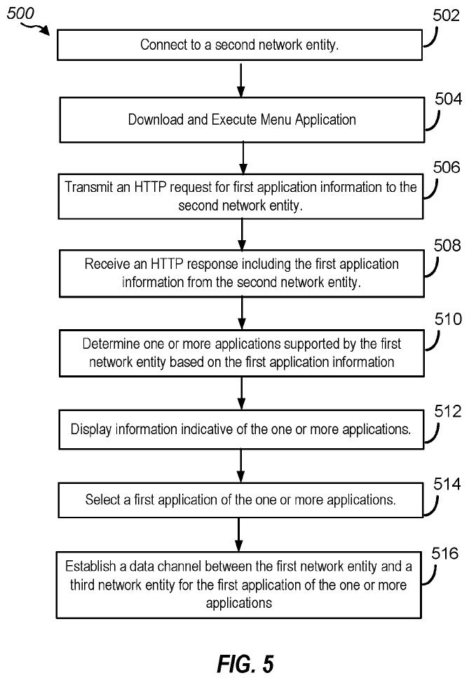

A first network node, such as a first UE, may communicate with a second network node, such as a data channel server, to determine one or more applications available for use with the second network node that are supported by the first network node. An example method 500 performed by a first network node, is shown in FIG. 5. At 502, the first network node may connect to a second network node. For example, the first network node may establish a bootstrap data channel, such as a bootstrap IMS data channel, between the first network node and the second network node.

At 504, the first network node may download and execute a menu application. For example, the first network node may download the menu application from the second network node using the established bootstrap data channel. The menu application may be a bootstrap menu application. In some embodiments, the menu application may be preloaded on the first network node and may be executed by the UE. In some embodiments, the UE may operate without downloading or executing a menu application. The menu application may include code for causing a processor of the first network node to determine network node capability information, as described with respect to 702, transmit an HTTP request, as described with respect to 506, receive an HTTP response, as described with respect to 508, determine one or more applications supported by the first network node, as described with respect to 510, display information, as described with respect to 512, select a first application, as described with respect to 514, or establish a data channel between the first network node and a third network node, as described with respect to 516. For example, the first network node may download a menu application including code for performing one or more operations described herein, such as one or more operations of the method 500. The menu application may facilitate transmission of HTTP requests and receipt of HTTP responses at the application layer.

At 506, the first network node may transmit an HTTP request for first application information to the second network node. The HTTP request may be an HTTP get and may be transmitted via the bootstrap data channel. In some embodiments, the HTTP request may include a request for application information from the data channel server. For example, the HTTP request may include a request for application information including a list of one or more applications supported by or available for download from the second network node, respective capability requirement information of each of the respective one or more applications, or a list of applications both supported by or available for download from the second network node and supported by the first network node. In some embodiments, the HTTP request may include network node capability information for the first network node detailing one or more software or hardware capabilities of the first network node to allow the second network node to determine one or more applications supported by the first network node.

At 508, the first network node may receive an HTTP response from the second network node. The HTTP response may be an HTTP OK and may be received via the bootstrap data channel. The HTTP response may include application information from the second network node. The application information may include a list of applications supported by or available for download from the second network node. The applications may, for example, include text chat applications, video chat applications, voice chat applications, and other applications. The application information may also include respective capability requirement information for each of the respective applications The application information may include a list of applications supported by or available for download from the second network node that are also supported by the first network node. For example, if the first network node transmitted network node capability information of the first network node to the second network node, the second network node may determine whether one or more capabilities of the first network node satisfy one or more respective capability requirements of one or more respective applications supported by or available for download from the second network node. The application information of the HTTP response may then include information indicating whether one or more capability requirements of the one or more applications are satisfied by capability requirement information of the first network node. For example, the application information may include a list of applications supported by the first network node or indicators of which applications listed in the application information of the HTTP response are supported by the first network node. A list of application supported by the first network node may, for example, be included in an HTML index page included in the HTTP response. In some embodiments, both applications determined to have capability requirements satisfied by network node capability information of the first network node and applications determined to have capability requirements unsatisfied by capability information of the first network node may be included in such an index page, but links to download applications having one or more capability requirements unsatisfied by the network node capability information of the first network node may be disabled.

At 510, the first network node may determine one or more applications supported by the first network node based on the first application information. For example, if the first application information includes information indicative of whether the network node capability information of the first network node satisfies one or more capability requirements of the one or more applications, such as a list of applications supported by the first network node, the first network node may determine that such applications are supported by the first network node. If the first application information includes respective capability requirement information for each of the one or more applications supported or available for download from the second network node, the first network node may compare the respective capability requirement information for each respective application with network node capability information of the first network node to determine if the network node capability information of the first network node satisfies the capability requirements of each respective application. Applications having capability requirements that are satisfied by the capabilities for the first network node may be determined to be supported by the first network node. For example, for a first application the application information may include an indication that the application requires video and positioning capabilities in the first network node. If the first network node supports use of video and positioning capabilities, the first network node may determine that the first application is supported. If an application requires multiple capabilities, the first network node may determine that the application is not supported if any of the required capabilities are not supported by the first network node. Alternatively, if the application requires certain capabilities to access certain application features, the first network node may determine that an application is supported, or partially supported, when the first network node possesses a capabilities required by some features of the application, but not all capabilities required by all features of the application. In some embodiments, applications that are partially supported by the first network node may be displayed or otherwise indicated separately from applications for which all capability requirements are met by the first network node.

At 512, the first network node may display information indicative of the one or more applications determined to be supported by the first network node. For example, the first network node may display on a display of the first network node a list of applications supported by the first network node for selection of one or more applications by a user. In some embodiments, the first network node may display applications that are supported by the first network node, applications that are partially supported by the first network node, and applications that are not supported by the first network node, with indications on the display of whether the applications are supported, partially supported, or not supported. In some embodiments, display of the information may include generation of information indicative of the one or more applications for provision on a display, display of such information on an external display, transmission of such information to a display processor, or other display of information indicative of the one or more applications.

At 514, the first network node may select a first application of the one or more applications. In some embodiments, the first network node may select an application of the one or more applications supported by the first network node without display of the supported applications. In some embodiments, first network node may receive an instruction from a user, such as selection of an application displayed on a display of the first network node, and may select one or more applications of the applications supported by the first network node based on the received instruction. In some embodiments, the first network node may automatically select one or more applications using one or more machine learning or AI algorithms. Selection of the first application may, for example, include downloading the first application from the second network node.

At 516, the first network node may establish a data channel between the first network node and a third network node, such as a second UE, for the selected first application of the one or more applications supported by the UE. For example, the second network node may facilitate connection of the first network node to the third network node via a data channel for the selected application. In some embodiments, the third network node may perform similar steps to those performed by the first network node at 502-516, to determine that the application is supported by the third network node. The first network node and the third network node may then communicate using the application via the data channel established at 516.

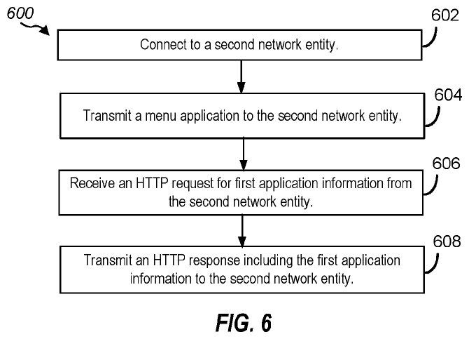

A first network node, such as data channel server, may communicate with a second network node, such as a first UE, to determine one or more applications for use with the first network node that are supported by the second network node. An example method 600 performed by a first network node is shown in FIG. 6. The method 600 may, for example, be performed by a data channel server in communication with a UE performing the method 500 of FIG. 5.

At 602, the first network node may connect to a second network node. For example, the first network node may communicate with the second network node to establish a data channel, such as a bootstrap IMS data channel, between the first network node and the second network node. The bootstrap IMS data channel may be used to transmit and receive HTTP requests for application information, HTTP responses including application information, network node capability information, and other information. Application information may include applications, such as executable code for one or more applications, information about applications, such as a list of applications supported by or available for download from the first network node, network node capabilities required for execution of such applications, or other information.

At 604, the first network node may transmit a menu application to the second network node. The menu application may be transmitted via a bootstrap data channel between the first and second network entities. The menu application may, for example, be an application for execution by the second network node, such as a UE, for determining and/or downloading applications supported by the second network node. For example, the menu application may include computer code for causing the second network node to determine network node capability information of the second network node, transmit an HTTP request to the first network node requesting application information, determine one or more applications supported by the second network node based on application information, and other functions performed by the second network node.

At 606, the first network node may receive an HTTP request for application information from the second network node. In some embodiments, the first network node may receive an HTTP request for application information from the second network node without transmitting the menu application to the second network node. For example, the second network node may transmit such a request using a menu application preloaded on the second network node or without use of a menu application. The HTTP request may be received via a bootstrap data channel between the first network node and the second network node. The HTTP request may, for example, be an HTTP get message. In some embodiments, the HTTP request may include network node capability information, such as information indicating one or more hardware or software capabilities of the second network node.

At 608, the first network node may transmit an HTTP response including the first application information to the second network node. In some embodiments, the first network node may generate the HTTP response as described with respect to block 414 of FIG. 4. In some embodiments, the first application information may include a list of applications supported by or available for download from the first network node along with respective capability requirement information, such as one or more respective network node capabilities required for execution, for each respective application. In some embodiments, such as when the first network node received network node capability information for the second network node in the HTTP request or otherwise has access to network node capability information for the second network node, such as network node capability information stored in a memory of the first information handling system, the first network node may compare the network node capability information for the second network node with capability requirement information for one or more applications supported by or available for download from the first network node. For example, the first network node may compare a list of network node capabilities for the second network node with a list of network node capabilities required for a first application to determine if the network node capabilities required for the first application are satisfied by the network entity capability information of the second network node. The first network node may repeat such a process for other applications available for download from or supported by the first network node to determine one or more applications having network node capability requirements that are satisfied by the network node capabilities of the second network node. The first network node may then include information indicative of whether the network node capability information of the second network node satisfies one or more respective capability requirements of each of one or more applications in the application information of the HTTP response. For example, the first network node may include a list of applications, if any, having network node capability requirements satisfied by the network node capabilities of the second network node in the application information of the HTTP response. Alternatively or additionally, the first network node may include a list of applications including both applications having network node capability requirements satisfied by the network node capability information of the second network node and applications having network node capability requirements unsatisfied by the network node capability information of the second network node, along with information indicating which applications are supported by the second network node and which applications are unsupported by the second network node, in the application information. Thus, the first network node may provide the second network node with an HTTP response including the first application information to the second network node.

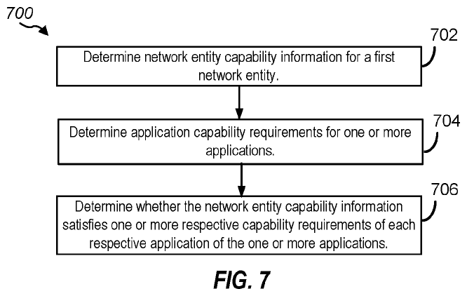

A first network node, such as a UE, or a second network node, such as a data channel server may determine one or more applications supported by the first network node based on application information and network node capability information for the first network node. An example method 700 for making such a determination is shown in FIG. 7. At 702, network node capability information for a first network node may be determined. Network node capability information may include hardware or software capabilities of a network node. For example, network node capability information may include video encoding and decoding capability information, audio encoding and decoding capability information, parallel encoding and decoding capability information, visual rendering capability information, such as graphics processing unit (GPU) capability information, audio rendering capability information, artificial intelligence capability information, positioning capability information, such as global positioning service (GPS) capability information, augmented reality communication capability information, short message service (SMS) capability information, multimedia message service (MMS) capability information, storage capability information, two dimensional camera capability information, three dimensional camera capability information, pose generation capability information, microphone capability information, speaker capability information, WiFi capability information, Bluetooth capability information, 5G capability information, haptic sensor capability information, electrical heart sensor capability information, drone control capability information, gyroscopic sensor capability information, infrared unit capability information, or other capability information. For example, such capability information may include details regarding hardware components of the first network node, such as identification of a specific camera or processor of the first network node or identification of a resolution of a camera of the first network node, or other hardware information. Alternatively or additionally, such information may include details regarding software components of the first network node, such as an operating system version of the first network node, a firmware version of the first network node, an application downloaded on the first network node, or other software information. Network entity capability information may further include information regarding permissions for hardware or resource access by data channel applications.

In some embodiments, such a determination may be made by a first network node, such as a UE. For example, a UE may determine one or more hardware or software capabilities of the UE. Such a determination may be made by an application, such as a menu application, executed by the UE, or may be otherwise made by the UE. For example, the first network node may scan hardware and software capabilities of the first network node to determine the network node capability information. As another example, the first network node may have a list of hardware or software capabilities preloaded or maintained on the first network node and may access such a list to determine the network node capability information. In some embodiments, a determination of network node capability information may be performed prior to transmission of an HTTP request for first application information, such as transmission of an HTTP request at 506 of method 500 of FIG. 5, and such an HTTP request may include the determined network node capability information of the first network node. In some embodiments, the application downloaded and executed at 504 of FIG. 5 may perform the described determination of network node capability information.

In some embodiments, a determination of network node capability information at 702 may be performed by the second network node. For example, network node capability information for the first network node may be received from the first network node in an HTTP request, such as the HTTP request of 606 of FIG. 6, and the second network node may determine the network node capability information of the first network node by extracting the information from the HTTP request. Thus, in some embodiments determination of network node capability information may be performed by a UE, in some embodiments determination of network node capability information may be performed by a data channel server, and in some embodiments determination of network node capability information may be performed by both the UE and the data channel server.

At 704, capability requirement information for one or more applications may be determined. Capability requirement information may, for example, include a list of hardware or software capabilities required for execution of an application or one or more features of an application. Thus, determined capability requirement information may include a list of respective capabilities required for each respective application of one or more applications. Capability requirement information for an application may include hardware or software capability requirements for a network node executing the application. For example, capability requirement information may include video encoding and decoding capability requirement information, audio encoding and decoding capability requirement information, parallel encoding and decoding capability requirement information, visual rendering capability requirement information, such as graphics processing unit (GPU) capability requirement information, audio rendering capability requirement information, artificial intelligence capability requirement information, positioning capability requirement information, such as global positioning service (GPS) capability requirement information, augmented reality communication capability requirement information, short message service (SMS) capability requirement information, multimedia message service (MMS) capability requirement information, storage capability requirement information, two dimensional camera capability requirement information, three dimensional camera capability requirement information, pose generation capability requirement information, microphone capability requirement information, speaker capability requirement information, WiFi capability requirement information, Bluetooth capability requirement information, 5G capability requirement information, haptic sensor capability requirement information, electrical heart sensor capability requirement information, drone control capability requirement information, gyroscopic sensor capability requirement information, infrared unit capability requirement information, or other capability requirement information. For example, such capability requirement information may include details regarding hardware component requirements for execution of a first application, such identification of a resolution of a camera required for execution of an application, or other hardware information. Capability requirement information may further include information regarding required permissions of hardware or software resource access by the application. Alternatively or additionally, such information may include details regarding software requirements, such as a required operating system version for execution of the application, a required firmware version for execution of the application, a required other application downloaded for execution of the application, or other software information.

In some embodiments, capability requirement information may include respective capabilities required for respective features of a respective application. For example, a communication application may include augmented reality video and voice chat features. The video chat feature capability requirements may include capability requirements such as a camera capability requirement, such as a two dimensional or three dimensional camera capability requirement, a microphone capability requirement, a speaker capability requirement, and an augmented reality capability requirement, such as an augmented reality GPU requirement. The voice chat feature capability requirements may include a microphone capability requirement and a speaker capability requirement.

In some embodiments, determination of capability requirement information may be performed by the first network node, such as the UE. For example, a first network node may determine application capability requirements from application information received in an HTTP response, such as application information received in the HTTP response of 508 of the method 500 of FIG. 5. Respective capability requirements for one or more respective applications may be extracted from the application information of the HTTP response by the receiving first network node. For example, a list of applications may be received in the HTTP response, along with respective capability requirement information for each respective application of the list of applications.

In some embodiments, determination of capability requirement information may be performed by the second network node, such as the data channel server. For example, a second network node may store capability requirement information for applications supported by or available for download from the second network node and may access such capability requirement information. Alternatively or additionally, capability requirement information may be otherwise determined by the second network node. For example, the second network node may receive capability requirement information for an application when the application is uploaded to the data channel server for provision to other network entities. As one example, the data channel server may determine capability requirement information following receipt of an HTTP request for application information, such as the HTTP request received at 606 of method 600 of FIG. 6. Such capability requirement information may be determined for inclusion in an HTTP response, such as the HTTP response of 608 of method 600 of FIG. 6 or to be used in determining, by the second network node, whether capability requirement information of one or more applications supported by or available for download from the second network node is satisfied by network node capability information of the first network node. When the capability requirement information is included in application information of an HTTP response transmitted to the first network node, the first network node may, as described herein, also determine the capability requirement information based on the application information of the HTTP response. Thus, in some embodiments, determination of capability requirement information may be performed by a UE, in some embodiments, determination of capability requirement information may be performed by a data channel server, and in some embodiments determination of capability requirement information may be performed by both the UE and the data channel server.

At 706, a determination may be made of whether the network node capability information satisfies one or more respective capability requirements of each respective application of the one or more applications. For example, network node capability information for the first network node may be compared with capability requirement information for an application to determine if the network node capabilities satisfy the capability requirements of the application. Such a comparison may be performed for multiple applications. In some embodiments, capability requirements for specific features of a single application may be compared with network node capability information to determine whether the specific features of the application are supported by the first network node.

As one example, a first network node may have microphone capabilities and speaker capabilities but not camera capabilities, as specified by network node capability information of the first network node. A first application may have a voice chat feature having microphone capability requirements and speaker capability requirements but not camera capability requirements, and a video chat feature having microphone, speaker, and camera capability requirements. Thus, the network node capability information of the first network node may be compared with the capability requirements of the voice chat feature and the video chat feature to determine that the network node capability information of the first network node satisfies the capability requirements of the voice chat feature but not the capabilities of the video chat feature. If the network node capability information satisfies the capability requirements of a feature, the feature may be determined to be supported, and if the network node capability information does not satisfy the capability requirements of a feature, the feature may be determined to be unsupported. If one or more features of an application are determined to be supported by the first network entity, while one or more other features of the first application are determined to be unsupported, if the first application is selected for downloading and/or execution, such as at 514 of method 500 of FIG. 5, the features of the application that are determined to be supported may be enabled, while the features of the application that are determined to be unsupported may be disabled upon execution of the application.

In some embodiments, the determination of whether the network node capability information satisfies one or more respective capability requirements of each respective application of the one or more applications may be performed by the first network node, such as the UE. For example, application information received from the second network node in the HTTP response, such as the HTTP response of 508 of FIG. 5, may include respective capability requirement information for each of one or more respective applications of the application information. The first network node may compare network node capability information of the first network node with capability requirement information of the application information to determine whether the network node capability information of the first network node satisfies one or more respective capability requirements of the one or more applications. Such a determination may, for example, be performed as part of the determination of one or more applications supported by the first network node based on the application information at 508 of method 500 of FIG. 5. For example, if all capability requirements of an application are satisfied by capabilities of the first network node, the first network node may determine that the application is supported by the first network node.

In some embodiments, the determination of whether the network node capability information satisfies one or more respective capability requirements of each respective application of the one or more applications may be performed by the second network node, such as the data channel server. For example, following receipt of an HTTP request including network node capability information of the first network node, such as receipt of an HTTP request at 606 of the method 600 of FIG. 6, or other determination of network node capability information for the first network node, the second network node may compare the network node capability information of the first network node with respective capability requirement information for each of one or more respective applications supported by or available for download from the second network node to determine whether the network node capability requirement information of the first network node satisfies one or more respective capability requirements of the one or more respective applications.

As one example, network node capability information of a first network node may be compared with a list of capabilities required by a first application. If each of the required capabilities is present in the network node capability information for the first network node, the required capabilities may be satisfied and the application may be supported by the first network node. If any of the required capabilities are not present in the network node capability information for the first network node, the application may not be supported by the first network node. Following a determination of whether the network node capability information satisfies one or more respective capability requirements of each respective application of the one or more applications, the second network node may include information indicative of whether the network node capability information satisfies one or more respective capability requirements of each respective application of the one or more applications in an HTTP response, such as the HTTP response transmitted at 608 of method 600 of FIG. 6 or received at 508 of the method 500 of FIG. 5. In some embodiments, the first network node may determine whether the network node capability information satisfies one or more respective capability requirements of each respective application of the one or more applications, based on such indicative information as part of the determination at 510 of method 500 of FIG. 5. Thus, in some embodiments, determination of whether the network node capability information satisfies one or more respective capability requirements of each respective application of the one or more applications may be performed by the first network node, by the second network node, or by both the first and second network nodes. Each of the determinations of method 700 may thus be performed by the first network node, the second network node, or a both the first network node and the second network node.

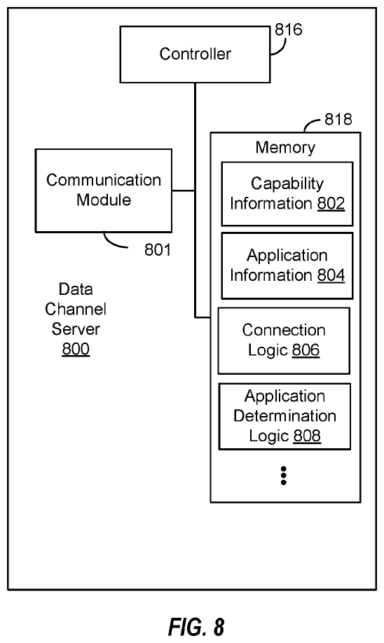

FIG. 8 is a block diagram of an example base station 800 that supports network node data channel application support determination according to one or more aspects. Data channel server 800 may be configured to perform operations, including the blocks of processes 600 and 700 described with reference to FIGS. 6 and 7, or to operate according to the timing diagram 400 of FIG. 4. In some implementations, data channel server 800 includes the structure, hardware, and components shown and described with reference to base station 105 of FIGS. 1-2, such as when the data channel server is integrated into a base station 105. In some implementations data channel server includes the structure, hardware, and components shown and described with reference to data channel server 120 of FIGS. 1 and 3. Data channel server 800 may include controller 816, which operates to execute logic or computer instructions stored in memory 818, as well as controlling the components of data channel server 800 that provide the features and functionality of data channel server 800. Data channel server 800, under control of controller 816, may transmit and receive signals, such as HTTP requests and responses, via communication module 801. Communication module 801 may include an ethernet module, a Wi-Fi module, a Bluetooth module, one or more wireless radios or antennas, or other communication components. For example, in some embodiments, the communication module 801 may include wireless radios, such as when the data channel server 800 is integrated into a base station, including various components and hardware, as illustrated in FIG. 2 for base station 105, including modulator and demodulators 232a-t, transmit processor 220, TX MIMO processor 230, MIMO detector 236, and receive processor 238. In some embodiments, the data channel server 800 may communicate with a base station having such wireless radios using the communication module 801, such as via a Wi-Fi or ethernet connection. Similar components and hardware may be present in a data channel server 120 or a data channel server 120 may connect to a base station 105 having such components and hardware.

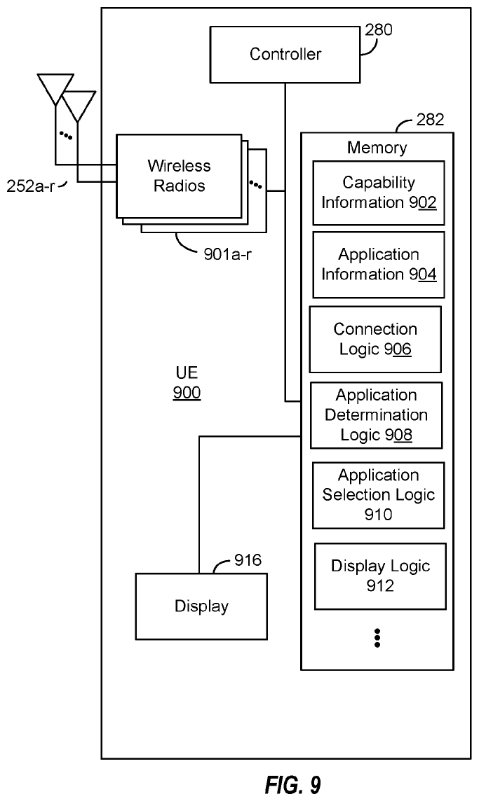

As shown, the memory 242 may include capability information 802, application information 804, connection logic 806, and application determination logic 808. Capability information 802 may be information regarding one or more hardware or software capabilities of one or more UEs. Application information 804 may be information regarding one or more applications supported by or available for download from the data channel server such as a list of such applications, respective capability requirement information for each respective application of the one or more applications, executable application files for the one or more applications downloadable from the data channel server, such as a menu application file, a text communication application file, a voice communication application file, a video communication application file, and other application files, information indicating whether one or more respective capability requirements of the one or more respective applications are satisfied by respective capability requirement information of one or more respective UEs, and other application information. Connection logic 804 may be configured to establish one or more connections, such as one or more data channels, between the data channel server 800 and one or more UEs. Application determination logic 808 may be configured to determine one or more respective applications supported by or available for download from the data channel server that are supported by one or more respective capability requirements of a UE. Data channel server 800 may receive signals from or transmit signals to one or more UEs, such as UE 115 of FIGS. 1-4 or UE 900 of FIG. 9.

FIG. 9 is a block diagram of an example UE 900 that supports network node data channel application support determination according to one or more aspects. UE 900 may be configured to perform operations, including the blocks of processes 500 and 700 described with reference to FIGS. 5 and 7. In some implementations, UE 900 includes the structure, hardware, and components shown and described with reference to UE 115 of FIGS. 1-3. For example, UE 900 includes controller 280, which operates to execute logic or computer instructions stored in memory 282, as well as controlling the components of UE 900 that provide the features and functionality of UE 900. UE 900, under control of controller 280, transmits and receives signals via wireless radios 901a-r and antennas 252a-r. Wireless radios 901a-r include various components and hardware, as illustrated in FIG. 2 for UE 115, including modulator and demodulators 254a-r, MIMO detector 256, receive processor 258, transmit processor 264, and TX MIMO processor 266.

As shown, the memory 282 may include capability information 902, application information 904, connection logic 908, application determination logic 908, application selection logic 910, and display logic 912. Capability information 902 may be information regarding one or more hardware or software capabilities of the UE 900. Application information 904 may be information regarding one or more applications supported by or available for download from a data channel server such as a list of such applications, respective capability requirement information for each respective application of the one or more applications, executable application files for the one or more applications downloadable from the data channel server, such as a menu application file, a text communication application file, a voice communication application file, a video communication application file, and other application communication files, information indicating whether one or more respective capability requirements of the one or more respective applications are satisfied by respective capability requirement information of the UE 900, or other application information. Connection logic 906 may be configured to establish one or more connections, such as one or more data channels, between a data channel server and the UE 900. Application determination logic 908 may be configured to determine one or more respective applications supported by or available for download from a data channel server that are supported by one or more respective capability requirements of the UE 900. Application selection logic 910 may be configured to select one or more applications that are determined to be supported by the UE 900 for download or execution. Display logic 912 may be configured to display information indicative of one or more applications determined to be supported by the UE 900, such as for selection of an application of the one or more applications by a user. UE 900 may receive signals from or transmit signals to one or more data channel servers, such as data channel server 120 of FIGS. 1, 3-4 or data channel server 800 of FIG. 8.

It is noted that one or more blocks (or operations) described with reference to FIGS. 4-7 may be combined with one or more blocks (or operations) described with reference to another of the figures. For example, one or more blocks (or operations) of FIG. 7 may be combined with one or more blocks (or operations) of FIG. 4, FIG. 5, or FIG. 6. As another example, one or more blocks associated with FIGS. 4, 5, 6, or 7 may be combined with one or more blocks (or operations) associated with FIGS. 1-3, 8, or 9. Additionally, or alternatively, one or more operations described above with reference to FIGS. 1-3 may be combined with one or more operations described with reference to FIGS. 8 or 9.

In one or more aspects, techniques for supporting network node data channel application support determination may include additional aspects, such as any single aspect or any combination of aspects described below or in connection with one or more other processes or devices described elsewhere herein. In a first aspect, supporting network node data channel application support determination may include a first network node configured to connect to a second network node, transmit an HTTP request for first application information to the second network node, receive an HTTP response including the first application from the second network node, determine one or more applications supported by the first network node based on the first application information, and at least one of display information indicative of the one or more applications or select a first application of the one or more applications. Additionally, the first network node may perform or operate according to one or more aspects as described below. In some implementations, the first network node may include a wireless device, such as a UE. In some implementations, the first network node may include at least one processor, and a memory coupled to the processor. The processor may be configured to perform operations described herein with respect to the first network node such as to execute first code stored on a memory of the first network node to cause the first network node to perform operations described herein with respect to the first network node. In some other implementations, the first network node may include a non-transitory computer-readable medium having program code recorded thereon and the program code may be executable by a computer for causing the computer to perform operations described herein with reference to the first network node. In some implementations, the first network node may include one or more means configured to perform operations described herein. In some implementations, a method of wireless communication may include one or more operations described herein with reference to the first network node.

In a second aspect, alone or in combination with the any of the above aspects, the first application information includes respective capability requirement information corresponding to each respective application of the one or more applications, and to determine the one or more applications supported by the first network node, the first network node may determine the one or more applications supported by the first network node based on network node capability information of the first network node and the first application information.

In a third aspect, alone or in combination with the any of the above aspects, the HTTP request includes network node capability information of the first network node, and the first application information includes information indicative of whether the network node capability information satisfies one or more respective capability requirements of each respective application of the one or more applications.

In a fourth aspect, alone or in combination with the any of the above aspects, the network node capability information comprises at least one of codec capability information, artificial intelligence capability information, positioning capability information, augmented reality communication capability information, short message service (SMS) capability information, multimedia messaging service (MMS) capability information, storage capability information, camera capability information, microphone capability information, speaker capability information, WiFi capability information, Bluetooth capability information, haptic sensor capability information, electrical heart sensor capability information, infrared scanner capability information, drone control capability information, gyroscopic sensor capability information, or infrared unit capability information.

In a fifth aspect, alone or in combination with the any of the above aspects, to connect to the second network node, the first network node is configured to establish a bootstrap internet protocol multimedia subsystem (IMS) data channel between the first network node and the second network node, to transmit the HTTP request, the first network node is configured to transmit the HTTP request via the bootstrap IMS data channel, and to receive the HTTP request, the first network node is configured to receive the HTTP response via the bootstrap IMS data channel.

In a sixth aspect, alone or in combination with the any of the above aspects, the first network node is configured to download a menu application from the second network node, wherein the menu application comprises second code for at least one of: causing the first network node to determine network node capability information of the first network node, causing the first network node to transmit the HTTP request, or causing the first network node to determine one or more applications supported by the first network node based on the first application information.

In a seventh aspect, alone or in combination with the any of the above aspects, the first network node comprises a user equipment (UE), and the second network node comprises a data channel server.

In an eighth aspect, alone or in combination with the any of the above aspects, the one or more applications comprise at least one of: a voice chat application, a text chat application, or a video chat application.

In a ninth aspect, alone or in combination with the any of the above aspects, the first network node is configured to establish a data channel between the first network node and a third network node for the first application of the one or more applications.

In one or more aspects, techniques for supporting network node data channel application support determination may include additional aspects, such as any single aspect or any combination of aspects described below or in connection with one or more other processes or devices described elsewhere herein. A tenth aspect, supporting data channel application support determination, may include a first network node configured to connect to a second network node, receive an HTTP request for first application information from the second network node, and transmit an HTTP response including the first application information to the second network node. Additionally, the first network node may perform or operate according to one or more aspects as described below. In some implementations, the first network node includes a wireless device, such as a data channel server. In some implementations, the first network node may include at least one processor, and a memory coupled to the processor. The processor may be configured to perform operations described herein with respect to the first network node such as to execute first code stored on a memory of the first network node to cause the first network node to perform operations described herein with respect to the first network node. In some other implementations, the first network node may include a non-transitory computer-readable medium having program code recorded thereon and the program code may be executable by a computer for causing the computer to perform operations described herein with reference to the first network node. In some implementations, the first network node may include one or more means configured to perform operations described herein. In some implementations, a method of wireless communication may include one or more operations described herein with reference to the first network node.

In an eleventh aspect, alone or in combination with the any of the above aspects, the first application information includes respective capability requirement information corresponding to each respective application of one or more applications.

In a twelfth aspect, alone or in combination with the any of the above aspects, the HTTP request includes network node capability information of the second network node and the first application information includes information indicative of whether the network node capability information satisfies one or more respective capability requirements of each of one or more applications.

In a thirteenth aspect, alone or in combination with the any of the above aspects, the network node capability information of the first network node comprises at least one of: video encoding and decoding capability information, audio encoding and decoding capability information, parallel encoding and decoding capability information, visual rendering capability information, audio rendering capability information, artificial intelligence capability information, positioning capability information, augmented reality communication capability information, short message service (SMS) capability information, multimedia messaging service (MMS) capability information, storage capability information, two dimensional camera capability information, three dimensional camera capability information, pose generation capability information, microphone capability information, speaker capability information, WiFi capability information, Bluetooth capability information, 5G capability information, haptic sensor capability information, electrical heart sensor capability information, infrared scanner capability information, drone control capability information, gyroscopic sensor capability information, or infrared unit capability information.

In a fourteenth aspect, alone or in combination with the any of the above aspects, to connect to the second network node, the first network node is configured to establish a bootstrap internet protocol multimedia subsystem (IMS) data channel between the first network node and the second network node, to receive the HTTP request, the first network node is configured to receive the HTTP request via the bootstrap IMS data channel, and to transmit the HTTP response, first network node is configured to transmit the HTTP response via the bootstrap IMS data channel.

In a fifteenth aspect, alone or in combination with the any of the above aspects, the first network node is configured to transmit a menu application to the second network node, wherein the menu application comprises second code for at least one of: causing the second network node to determine network node capability information of the second network node, causing the second network node to transmit the HTTP request to the first network node, or causing the second network node to determine one or more applications supported by the second network node based on the first application information.

In a sixteenth aspect, alone or in combination with the any of the above aspects, the first network node comprises a data channel server, and the second network node comprises a user equipment (UE).

In a seventeenth aspect, alone or in combination with the any of the above aspects, the one or more applications comprise at least one of: a voice chat application, a text chat application, or a video chat application.

In an eighteenth aspect, alone or in combination with the any of the above aspects, the memory of the first network node has respective capability requirement information for each respective application of one or more applications stored thereon.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A first network node comprising:
a memory having first code stored thereon; and
at least one processor coupled to the memory, wherein the at least one processor is configured to execute the first code to cause the first network node to:
connect to a second network node;
transmit a hypertext transfer protocol (HTTP) request for first application information to the second network node;
receive an HTTP response including the first application information from the second network node;
determine one or more applications supported by the first network node based on the first application information; and
at least one of:
display information indicative of the one or more applications, or
select a first application of the one or more applications.

2. The first network node of claim 1,
wherein the first application information includes respective capability requirement information corresponding to each respective application of the one or more applications, and
wherein to determine the one or more applications supported by the first network node, the at least one processor is configured to execute the first code to cause the first network node to determine the one or more applications supported by the first network node based on network node capability information of the first network node and the first application information.

3. The first network node of claim 1, wherein the HTTP request includes network node capability information of the first network node, and
wherein the first application information includes information indicative of whether the network node capability information satisfies one or more respective capability requirements of each respective application of the one or more applications.

4. The first network node of claim 3, wherein the network node capability information comprises at least one of:
codec capability information;
artificial intelligence capability information;
positioning capability information;
augmented reality communication capability information;
short message service (SMS) capability information;
multimedia messaging service (MMS) capability information;
storage capability information;
camera capability information;
microphone capability information;
speaker capability information;
WiFi capability information;
Bluetooth capability information;
haptic sensor capability information;
electrical heart sensor capability information;
infrared scanner capability information;
drone control capability information;
gyroscopic sensor capability information; or
infrared unit capability information.

5. The first network node of claim 1, wherein to connect to the second network node, the at least one processor is configured to execute the first code to cause the first network node to establish a bootstrap internet protocol multimedia subsystem (IMS) data channel between the first network node and the second network node, wherein to transmit the HTTP request, the at least one processor is configured to execute the first code to cause the first network node to transmit the HTTP request via the bootstrap IMS data channel, and wherein to receive the HTTP request, the at least one processor is configured to execute the first code to cause the first network node to receive the HTTP response via the bootstrap IMS data channel.

6. The first network node of claim 1, wherein the at least one processor is further configured to execute the first code to cause the first network node to:
download a menu application from the second network node,
wherein the menu application comprises second code for at least one of:
causing the first network node to determine network node capability information of the first network node,
causing the first network node to transmit the HTTP request, or
causing the first network node to determine one or more applications supported by the first network node based on the first application information.

7. The first network node of claim 1, wherein the first network node comprises a user equipment (UE), and wherein the second network node comprises a data channel server.

8. The first network node of claim 1, wherein the one or more applications comprise at least one of:
a voice chat application;
a text chat application; or
a video chat application.

9. The first network node of claim 1, wherein the at least one processor is further configured to execute the first code to cause the first network node to:
establish a data channel between the first network node and a third network node for the first application of the one or more applications.

10. A first network node, comprising:
a memory having first code stored thereon; and
at least one processor coupled to the memory, wherein the at least one processor is configured to execute the first code to cause the first network node to:
connect to a second network node;
receive a hypertext transfer protocol (HTTP) request for first application information from the second network node; and
transmit an HTTP response including the first application information to the second network node.

11. The first network node of claim 10, wherein the first application information includes respective capability requirement information corresponding to each respective application of one or more applications.

12. The first network node of claim 10, wherein the HTTP request includes network node capability information of the second network node, and wherein the first application information includes information indicative of whether the network node capability information satisfies one or more respective capability requirements of each of one or more applications.

13. The first network node of claim 12, wherein the network node capability information of the first network node comprises at least one of:
video encoding and decoding capability information;
audio encoding and decoding capability information;
parallel encoding and decoding capability information;
visual rendering capability information;
audio rendering capability information;
artificial intelligence capability information;
positioning capability information;
augmented reality communication capability information;
short message service (SMS) capability information;
multimedia messaging service (MMS) capability information;
storage capability information;
two dimensional camera capability information;
three dimensional camera capability information;
pose generation capability information;
microphone capability information;
speaker capability information;
WiFi capability information;
Bluetooth capability information;
5G capability information;
haptic sensor capability information;
electrical heart sensor capability information;
infrared scanner capability information;
drone control capability information;
gyroscopic sensor capability information; or
infrared unit capability information.

14. The first network node of claim 10, wherein to connect to the second network node, the at least one processor is configured to execute the first code to cause the first network node to establish a bootstrap internet protocol multimedia subsystem (IMS) data channel between the first network node and the second network node, wherein to receive the HTTP request, the at least one processor is configured to execute the first code to cause the first network node to receive the HTTP request via the bootstrap IMS data channel, and wherein to transmit the HTTP response, the at least one processor is configured to execute the first code to cause the first network node to transmit the HTTP response via the bootstrap IMS data channel.

15. The first network node of claim 10, wherein the at least one processor is further configured to execute the first code to cause the first network node to:
transmit a menu application to the second network node,
wherein the menu application comprises second code for at least one of:
causing the second network node to determine network node capability information of the second network node,
causing the second network node to transmit the HTTP request to the first network node, or
causing the second network node to determine one or more applications supported by the second network node based on the first application information.

16. The first network node of claim 10, wherein the first network node comprises a data channel server, and wherein the second network node comprises a user equipment (UE).

17. The first network node of claim 10, wherein the one or more applications comprise at least one of:
a voice chat application;
a text chat application; or
a video chat application.

18. The first network node of claim 10, wherein the memory of the first network node has respective capability requirement information for each respective application of one or more applications stored thereon.

19. A method of wireless communication performed by a first network node comprising:
connecting to a second network node;
transmitting a hypertext transfer protocol (HTTP) request for first application information to the second network node;
receiving an HTTP response including the first application information from the second network node;
determining one or more applications supported by the first network node based on the first application information; and
at least one of:
displaying information indicative of the one or more applications, or
selecting a first application of the one or more applications.

20. The method of claim 19,
wherein the first application information includes respective capability requirement information corresponding to each respective application of the one or more applications, and
wherein determining the one or more applications supported by the first network node comprises determining the one or more applications supported by the first network node based on network node capability information of the first network node and the first application information.

21. The method of claim 19, wherein the HTTP request includes network node capability information of the first network node, and
wherein the first application information includes information indicative of whether the network node capability information satisfies one or more respective capability requirements of each respective application of the one or more applications.

22. The method of claim 19, wherein connecting to the second network node comprises establishing a bootstrap internet protocol multimedia subsystem (IMS) data channel between the first network node and the second network node, wherein transmitting the HTTP request comprises transmitting the HTTP request via the bootstrap IMS data channel, and wherein receiving the HTTP response comprises receiving the HTTP response via the bootstrap IMS data channel.

23. The method of claim 19, further comprising:
downloading a menu application from the second network node,
wherein the menu application comprises first code for at least one of:
causing the first network node to determine network node capability information of the first network node,
causing the first network node to transmit the HTTP request, or
causing the first network node to determine one or more applications supported by the first network node based on the first application information.

24. The method of claim 19, wherein the first network node comprises a user equipment (UE), and wherein the second network node comprises a data channel server.

25. A method of wireless communication performed by a first network node, comprising:
connecting to a second network node;
receiving a hypertext transfer protocol (HTTP) request for first application information from the second network node; and
transmitting an HTTP response including the first application information to the second network node.

26. The method of claim 25, wherein the first application information includes respective capability requirement information corresponding to each respective application of one or more applications.

27. The method of claim 25, wherein the HTTP request includes network node capability information of the second network node, and wherein the first application information includes information indicative of whether the network node capability information satisfies one or more respective capability requirements of each of one or more applications.

28. The method of claim 25, wherein connecting to the second network node comprises establishing a bootstrap internet protocol multimedia subsystem (IMS) data channel between the first network node and the second network node, wherein receiving the HTTP request comprises receiving the HTTP request via the bootstrap IMS data channel, and wherein transmitting the HTTP response comprises transmitting the HTTP response via the bootstrap IMS data channel.

29. The method of claim 25, further comprising:
transmitting a menu application to the second network node,
wherein the menu application comprises second code for at least one of:
causing the second network node to determine network node capability information of the second network node,
causing the second network node to transmit the HTTP request to the first network node, or
causing the second network node to determine one or more applications supported by the second network node based on the first application information.

30. The method of claim 25, wherein the first network node comprises a data channel server, and wherein the second network node comprises a user equipment (UE).
